(19) United States
(12) Patent Application Publication
(10) Pub. No.: US 2024/0352609 A1
(43) Pub. Date: Oct. 24, 2024

(54) ELECTROLYTIC SYNTHESIS SYSTEM

(71) Applicant: HONDA MOTOR CO., LTD., TOKYO (JP)

(72) Inventors: Kazuki YANAGISAWA, WAKO-SHI (JP); Misato MAKI, WAKO-SHI (JP); Hideaki YONEDA, WAKO-SHI (JP); Jumpei YOSHIDA, WAKO-SHI (JP)

(21) Appl. No.: 18/632,659

(22) Filed: Apr. 11, 2024

(30) Foreign Application Priority Data
Apr. 18, 2023 (JP) 2023-067737

(51) Int. Cl. C25B 15/08; B01D 53/30; B01D 53/32; C25B 1/042; C25B 1/23; C25B 15/023; H01M 8/04537; H01M 8/04746; H01M 8/0656; H01M 8/18

(52) U.S. Cl. CPC C25B 15/081; B01D 53/30; B01D 53/326; C25B 1/042; C25B 1/23; C25B 15/023; H01M 8/04626; H01M 8/04753; H01M 8/0656; H01M 8/184; B01D 2257/504

(57) ABSTRACT

An electrolytic synthesis system is equipped with an electrolysis device, a synthesis device, a gas adsorption type storage battery, and a control device. The gas adsorption type storage battery adsorbs, to electrodes thereof, carbon dioxide gas within the atmosphere during charging, and releases the carbon dioxide gas that was adsorbed to the electrodes, during discharging. When an adsorption amount of the carbon dioxide gas adsorbed to the electrodes exceeds a predetermined first threshold value, the control device controls a discharging switch and thereby initiates discharging of the gas adsorption type storage battery.

### CROSS-REFERENCE TO RELATED APPLICATIONS

This application is based upon and claims the benefit of priority from Japanese Patent Application No. 2023-067737 filed on Apr. 18, 2023, the contents of which are incorporated herein by reference.

### BACKGROUND OF THE INVENTION

### Field of the Invention

The present disclosure relates to an electrolytic synthesis system.

### Description of the Related Art

In recent years, efforts have been made to significantly reduce the generation of waste by preventing or reducing the generation of such waste, as well as recycling and reusing such waste. Toward the realization thereof, research and development are being carried out in relation to an electrolytic synthesis system. The electrolytic synthesis system is equipped with an electrolysis device that subjects water vapor to electrolysis and thereby generates hydrogen gas, and a synthesis device that uses the hydrogen gas and thereby synthesizes hydrocarbons.

In JP 2008-204783 A, a system is disclosed including a solid oxide fuel cell and a methanation reactor. The solid oxide fuel cell is constituted by stacking a plurality of cells each of which includes a fuel electrode, an oxygen electrode, and an electrolyte membrane. A reformed gas generated by reforming a fuel is supplied to the fuel electrodes of the solid oxide fuel cell. Hydrogen and carbon monoxide or carbon dioxide are discharged from the fuel electrodes of the solid oxide fuel cell. The methanation reactor causes the hydrogen and the carbon monoxide or the carbon dioxide to react and thereby converts them into methane.

### SUMMARY OF THE INVENTION

In the case of generating electrical power with the solid oxide fuel cell, in order to supply the reformed gas to the solid oxide fuel cell, it is necessary to provide a reformer, a supply line, and the like. Further, in the case of supplying the carbon dioxide gas discharged from the solid oxide fuel cell to the methanation reaction device, the timing of supplying the carbon dioxide gas is limited to only being during operation of the solid oxide fuel cell. Therefore, the operating rate of the methanation reactor decreases.

The present invention has the object of solving the aforementioned problems.

An aspect of the present invention is characterized by an electrolytic synthesis system including an electrolysis device configured to carry out electrolysis on water vapor and thereby generate a hydrogen gas, a synthesis device configured to use the hydrogen gas and thereby synthesize hydrocarbon, a gas adsorption type storage battery configured to adsorb, to an electrode, a carbon dioxide gas within the atmosphere, together with electrons, during charging, and to release, from the electrode, together with the electrons, the carbon dioxide gas that was adsorbed to the electrode, during discharging, a first pipe that connects the gas adsorption type storage battery and the electrolysis device or the synthesis device, wherein carbon dioxide from the gas adsorption type storage battery flows through the first pipe, a discharging switch configured to supply electrical power of the gas adsorption type storage battery to the electrolysis device, an adsorption sensor configured to acquire an adsorption amount of the carbon dioxide gas adsorbed to the electrode, and a control device including one or more processors, wherein, in a case that the adsorption amount exceeds a predetermined first threshold value, the control device controls the discharging switch and thereby initiates discharging of the gas adsorption type storage battery.

According to the above-described aspect, electrical power can be stored without providing a reformer, a reformed gas supply line, or the like. As a result, it is possible to reduce restrictions on the installation location. Further, the carbon dioxide gas can be stably acquired owing to the gas adsorption type storage battery, and as a result, the operating rate of the methanation reactor can be increased.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram showing a configuration of an electrolytic synthesis system according to a first embodiment;

FIG. 2 is a flowchart showing a procedure of a system control process by a control device according to the first embodiment;

FIG. 3 is a schematic diagram showing the configuration of the electrolytic synthesis system according to an Exemplary Modification of the first embodiment;

FIG. 4 is a schematic diagram showing the configuration of the electrolytic synthesis system according to a second embodiment;

FIG. 5 is a flowchart showing a procedure of a system control process by a control device according to the second embodiment;

FIG. 6 is a schematic diagram showing the configuration of the electrolytic synthesis system according to an Exemplary Modification 1 of the second embodiment;

FIG. 7 is a schematic diagram showing the configuration of the electrolytic synthesis system according to an Exemplary Modification 2 of the second embodiment; and

FIG. 8 is a schematic diagram showing the configuration of the electrolytic synthesis system according to an Exemplary Modification 3 of the second embodiment.

### DETAILED DESCRIPTION OF THE INVENTION

### First Embodiment

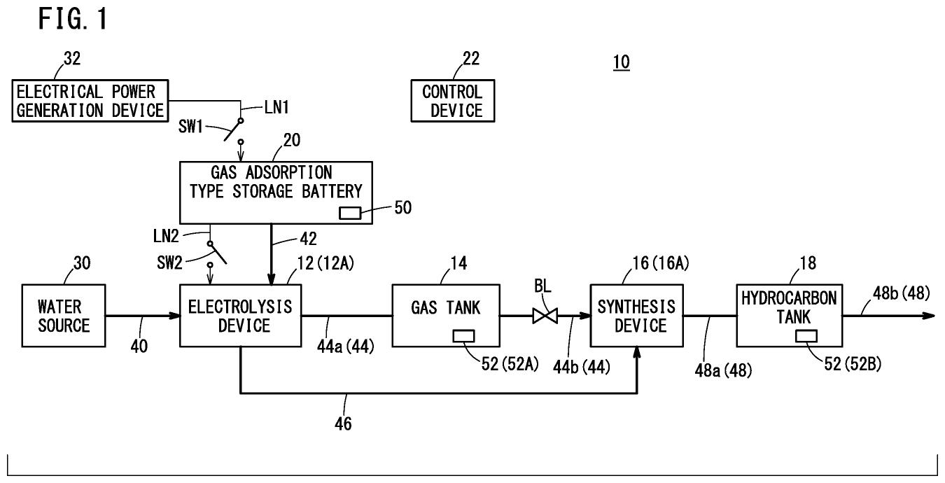

As shown in FIG. 1, an electrolytic synthesis system 10 is equipped with an electrolysis device 12, a gas tank 14, a synthesis device 16, a hydrocarbon tank 18, a gas adsorption type storage battery 20, and a control device 22.

The electrolysis device 12 is a device that subjects water to electrolysis. The electrolysis device 12 includes a cell stack in which a plurality of electrolytic cells are stacked. Each of the electrolytic cells includes an electrolyte membrane, a fuel electrode, and an oxygen electrode. The electrolyte membrane is sandwiched between the fuel electrode and the oxygen electrode.

According to the present embodiment, the electrolysis device 12 is a co-electrolysis device 12A that subjects water and carbon dioxide gas to co-electrolysis. The electrolyte membrane used in the co-electrolysis device 12A, for example, is a solid electrolyte membrane such as an yttria-stabilized zirconia or the like.

Water is supplied to the electrolysis device 12 from a water source 30 via a water supply path 40. The water that is supplied to the electrolysis device 12 may be liquid water or may be water vapor. The water supply path 40 is a pipe that places the fuel electrode of each of the electrolytic cells in the electrolysis device 12 in communication with the water source 30. Carbon dioxide gas is supplied to the electrolysis device 12 from the gas adsorption type storage battery 20 via a first pipe 42. The first pipe 42 places the fuel electrode of each of the electrolytic cells in the electrolysis device 12 in communication with the gas adsorption type storage battery 20. Oxygen gas is supplied to the electrolysis device 12 from an oxygen supply source (not shown) such as a blower or the like via an oxygen supply path (not shown). The oxygen supply path is a pipe that places the oxygen electrode of each of the electrolytic cells in the electrolysis device 12 in communication with the oxygen supply source.

The electrolysis device 12 begins carrying out electrolysis when electrical power is supplied thereto. When the electrolysis is started, according to the present embodiment, a generated gas including a hydrogen gas and a carbon monoxide gas is generated. The generated gas flows out into a second pipe 44. The second pipe 44 places the fuel electrode of each of the electrolytic cells in the electrolysis device 12 in communication with the synthesis device 16.

The operating temperature of the electrolysis device 12 is high in temperature, reaching several hundred degrees centigrade. In order for the synthesis device 16 to utilize the heat generated in the electrolysis device 12, the electrolysis device 12 and the synthesis device 16 are connected by way of a heat conduction pathway 46. The heat conduction pathway 46 is a pathway that serves to conduct the heat generated in the electrolysis device 12 to the synthesis device 16. The heat conduction pathway 46 may include a heat pipe.

The gas tank 14 is provided in the second pipe 44. An inlet port of the gas tank 14 is connected to a downstream end of an upstream portion 44a of the second pipe 44. An outlet port of the gas tank 14 is connected to an upstream end of a downstream portion 44b of the second pipe 44. The gas tank 14 stores the generated gas (the hydrogen gas and the carbon monoxide gas) that is generated by the electrolysis device 12. The generated gas that is stored in the gas tank 14 is supplied to the synthesis device 16.

The synthesis device 16 is a device that uses the hydrogen gas, and thereby synthesizes hydrocarbons. According to the present embodiment, the synthesis device 16 is a FT (Fischer-Tropsch) synthesis device 16A that causes the hydrogen gas and the carbon monoxide gas to react with each other, and thereby synthesizes the hydrocarbons. The generated gas (the hydrogen gas and the carbon monoxide gas) generated by the co-electrolysis device 12A is supplied from the gas tank 14 to the FT synthesis device 16A. The FT synthesis device 16A causes the reaction between the hydrogen gas and the carbon monoxide gas via a catalyst, and thereby synthesizes the hydrocarbons. The catalyst includes, for example, a metal such as cobalt or the like. The hydrocarbons synthesized by the synthesis device 16 are discharged into a hydrocarbon discharge path 48.

The hydrocarbon tank 18 is provided in the hydrocarbon discharge path 48. An inlet port of the hydrocarbon tank 18 is connected to a downstream end of an upstream portion 48a of the hydrocarbon discharge path 48. An outlet port of the hydrocarbon tank 18 is connected to an upstream end of a downstream portion 48b of the hydrocarbon discharge path 48. The hydrocarbon tank 18 stores the hydrocarbons that are synthesized by the synthesis device 16.

The gas adsorption type storage battery 20 is a device that adsorbs, onto the electrodes, carbon dioxide gas within the atmosphere during charging, and releases the carbon dioxide gas that was adsorbed onto the electrodes, during discharging. The gas adsorption type storage battery 20 includes a casing, and a plurality of electrical power storage cells arranged inside the casing. Each of the electrical power storage cells includes two electrodes containing a quinone-based material, and an electrolyte membrane sandwiched between the two electrodes. In the electrical power storage cells, during charging, the carbon dioxide inside the casing of the gas adsorption type storage battery 20 becomes bonded to the quinone-based substituent group together with the electrons. On the other hand, during discharging, the carbon dioxide gas that is bonded to the quinone-based substituent group is separated therefrom. This technique may be referred to as an Electric Swing Adsorption method. The carbon dioxide gas released from the electrodes of each of the electrical power storage cells passes through the first pipe 42, and is supplied to the fuel electrodes of the electrolysis device 12. Moreover, it should be noted that the interior of the casing of the gas adsorption type storage battery 20 is in communication with the atmosphere.

An electrical power generation device 32 is electrically connected to the gas adsorption type storage battery 20. According to the present embodiment, the electrical power generation device 32 is a solar electrical power generation device that converts solar energy into electrical power, however, the present embodiment is not limited to this feature. For example, the electrical power generation device may be a geothermal electrical power generation device, a wind electrical power generation device, or a hydroelectric electrical power generation device. In essence, the electrical power generation device may be a power generation device that generates renewable energy. Moreover, the electrical power generation device 32 may be connected as an electrical power source to the electrolysis device 12 and the synthesis device 16. In the case that the electrical power generation device 32 is not connected to the electrolysis device 12 or the synthesis device 16, the electrolysis device 12 and the synthesis device 16 are connected to another electrical power source.

A first charging switch SW1 is provided in a charging line LN1 that connects the electrical power generation device 32 and the gas adsorption type storage battery 20. The first charging switch SW1 is a switch in order to supply the electrical power of the electrical power generation device 32 to the electrolysis device 12. In the case that the first charging switch SW1 is turned OFF, the electrical power of the electrical power generation device 32 is not supplied to the gas adsorption type storage battery 20. On the other hand, in the case that the first charging switch SW1 is turned ON, the electrical power of the electrical power generation device 32 is supplied to the gas adsorption type storage battery 20.

The electrolysis device 12 is electrically connected to the gas adsorption type storage battery 20. A discharging switch SW2 is provided in a discharge line LN2 connecting the gas adsorption type storage battery 20 and the electrolysis device 12. The discharging switch SW2 is a switch for supplying electrical power of the gas adsorption type storage battery 20 to the electrolysis device 12. In the case that the discharging switch SW2 is turned OFF, the electrical power of the gas adsorption type storage battery 20 is not supplied to the electrolysis device 12. On the other hand, in the case that the discharging switch SW2 is turned ON, the electrical power of the gas adsorption type storage battery 20 is supplied to the electrolysis device 12.

The control device 22 is a computer that controls the electrolytic synthesis system 10. The control device 22 is equipped with an operation unit, a storage unit, and a computation unit. The operation unit is an input device that is capable of receiving instructions from the operator. A storage unit is a storage device that stores various data. The storage unit may be constituted by a volatile memory and a non-volatile memory. As an example of the volatile memory, there may be cited a RAM or the like. As an example of the non-volatile memory, there may be cited a ROM, a flash memory, or the like. The computation unit includes one or more processors such as a CPU, an MPU, or the like.

A plurality of sensors are connected to the control device 22. The plurality of sensors include an adsorption sensor 50 and two tank sensors 52.

The adsorption sensor 50 is provided in the gas adsorption type storage battery 20. The adsorption sensor 50 is a sensor that is used in order to acquire an adsorption amount of the carbon dioxide gas adsorbed to the electrodes of the electrical power storage cells.

The adsorption sensor 50, for example, is a current sensor. A relationship exists such that, as the adsorption amount of the carbon dioxide gas adsorbed to the electrodes of the electrical power storage cell becomes greater, the value of electrical current flowing through the electrodes becomes smaller. Stated otherwise, in the gas adsorption type storage battery 20, as the residual amount of the battery power becomes greater, the electrical current flowing therethrough becomes smaller. Further, as the electrical current flowing through the gas adsorption type storage battery 20 becomes smaller, the residual amount of the battery power becomes higher, and the adsorption amount becomes greater. Based on this relationship, the value (the electrical current value) detected by the adsorption sensor 50 can be converted into the adsorption amount of the carbon dioxide gas. The adsorption sensor 50 may be provided in each of the plurality of power storage cells. In this case, the adsorption amount of the carbon dioxide gas is converted from a statistical value such as an average of the values (the electrical current values) detected by the plurality of adsorption sensors 50. Alternatively, the adsorption sensor 50 may be provided in a representative one of the plurality of electrical power storage cells. In this case, the adsorption amount of the carbon dioxide gas is converted from the value (the electrical current value) detected by the representative one of the adsorption sensors 50. Moreover, it should be noted that the adsorption sensor 50 is not limited to being a current sensor.

One of the two tank sensors 52 is a tank sensor 52A that is provided in the gas tank 14. The tank sensor 52A is a sensor that is used in order to detect the stored amount of the generated gas that is stored in the gas tank 14. The remaining one of the two tank sensors 52 is a tank sensor 52B that is provided in the hydrocarbon tank 18. The tank sensor 52B is a sensor that is used in order to detect the stored amount of the hydrocarbons that are stored in the hydrocarbon tank 18.

The tank sensor 52, for example, is a pressure sensor. A relationship exists such that, as the stored amount of the gas that is stored in the tank becomes greater, the pressure within the tank becomes larger. Based on this relationship, the value (the pressure value) detected by the tank sensor 52 can be converted into the stored amount of the generated gas or the stored amount of the hydrocarbons. Moreover, it should be noted that the tank sensor 52 is not limited to being a pressure sensor.

The control device 22, based on the detection result of the adsorption sensor 50 and the detection results of the tank sensors 52, controls a plurality of control target components in the electrolytic synthesis system 10. The plurality of control target components include the water source 30, the first charging switch SW1, the discharging switch SW2, and an opening/closing valve BL. The opening/closing valve BL is provided in the second pipe 44 between the gas tank 14 and the synthesis device 16. The opening/closing valve BL may be provided in the outlet port of the gas tank 14. In the case that the opening/closing valve BL is closed, the generated gas that is stored in the gas tank 14 is not supplied to the synthesis device 16. On the other hand, in the case that the opening/closing valve BL is open, the generated gas that is stored in the gas tank 14 is supplied to the synthesis device 16.

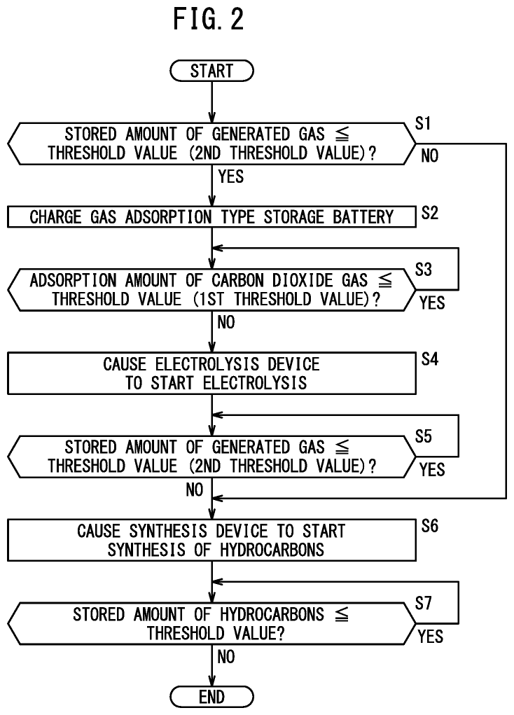

Next, in relation to a system control process of the control device 22, a description thereof will be given in detail using the flowchart shown in FIG. 2. During a time in which the electrolytic synthesis system 10 is stopped, when a command to start the electrolytic synthesis system 10 is received, the control device 22 initiates the system control process, and then transitions to step S1. Moreover, during the time in which the electrolytic synthesis system 10 is stopped, the water source 30 is stopped, the first charging switch SW1 and the discharging switch SW2 are turned OFF, and the opening/closing valve BL is closed.

In step S1, the control device 22, based on the tank sensor 52A, acquires the stored amount of the generated gas that is stored in the gas tank 14, and compares the stored amount with a predetermined threshold value (a second threshold value).

In the case that the stored amount of the generated gas exceeds the threshold value (the second threshold value), the control device 22 determines that there is no need to replenish the gas tank 14 with the generated gas. In this case, the control device 22 transitions to step S6. The content of step S6 will be described later. On the other hand, in the case that the stored amount of the generated gas is less than or equal to the threshold value (the second threshold value), the control device 22 determines that there is a need to replenish the gas tank 14 with the generated gas. In this case, the control device 22 transitions to step S2.

In step S2, the control device 22 turns ON the first charging switch SW1, and begins charging the gas adsorption type storage battery 20. Thereafter, the control device 22 transitions to step S3.

In step S3, the control device 22 acquires, based on the adsorption sensor 50, the adsorption amount of the carbon dioxide gas adsorbed to the electrodes of the electrical power storage cells, and compares the adsorption amount with a predetermined threshold value (a first threshold value).

In the case that the adsorption amount of the carbon dioxide gas is less than or equal to the threshold value (the first threshold value), the control device 22 determines that the gas adsorption type storage battery 20 does not have an amount of charge equivalent to electrical power to be supplied to the electrolysis device 12. In this case, the control device 22 remains at step S3. On the other hand, if the adsorption amount of the carbon dioxide gas exceeds the threshold value (the first threshold value), the control device 22 transitions to step S4.

In step S4, the control device 22, at first, turns OFF the first charging switch SW1. When the first charging switch SW1 becomes turned OFF, the carbon dioxide gas begins to be released from the electrodes of each of the electrical power storage cells of the gas adsorption type storage battery 20. The carbon dioxide gas released from the electrodes passes through the first pipe 42, and is supplied to the electrolysis device 12.

Thereafter, the control device 22, together with driving the water source 30, turns ON the discharging switch SW2, and then transitions to step S5. When the discharging switch SW2 becomes turned ON, the electrical power of the gas adsorption type storage battery 20 is supplied to the electrolysis device 12. When the electrical power is supplied thereto, the electrolysis device 12 begins electrolyzing the water supplied from the water source 30 and the carbon dioxide gas supplied from the gas adsorption type storage battery 20. When the electrolysis begins, the generated gas (the hydrogen gas and the carbon monoxide gas) that is generated by the electrolysis begins to be stored in the gas tank 14.

In step S5, the control device 22, based on the tank sensor 52A, acquires the stored amount of the generated gas that is stored in the gas tank 14, and compares the stored amount with the predetermined threshold value (the second threshold value). In the case that the stored amount of the generated gas is less than or equal to the threshold value (the second threshold value), the control device 22 remains at step S5 until the stored amount of the generated gas exceeds the threshold value (the second threshold value). On the other hand, when the stored amount of the generated gas exceeds the threshold value (the second threshold value), the control device 22, together with stopping the water source 30, turns OFF the discharging switch SW2, and transitions to step S6.

When the water source 30 is stopped, the supply of the water to the electrolysis device 12 also stops. When the discharging switch SW2 is turned OFF, the supply of the carbon dioxide gas to the electrolysis device 12 is stopped. Therefore, the electrolysis carried out by the electrolysis device 12 is stopped. Moreover, it should be noted that, in order for the synthesis device 16 to make use of the heat that is generated in the electrolysis device 12, the supply of the electrical power to the electrolysis device 12 is continued. The supply source may be the electrical power generation device 32, or may be an electrical power source other than the electrical power generation device 32.

In step S6, the control device 22 opens the opening/closing valve BL, supplies the hydrogen gas and the carbon monoxide gas that are stored in the gas tank 14 to the synthesis device 16, and thereby causes the synthesis device 16 to synthesize the hydrocarbons. Thereafter, the control device 22 transitions to step S7.

In step S7, the control device 22, based on the tank sensor 52B, acquires the stored amount of the hydrocarbons that are stored in the hydrocarbon tank 18, and compares the stored amount with a predetermined threshold value. In the case that the stored amount of the hydrocarbons is less than or equal to the threshold value, the control device 22 remains at step S7, until the stored amount of the hydrocarbons exceeds the threshold value. On the other hand, in the case that the stored amount of the hydrocarbons exceeds the threshold value, the control device 22 closes the opening/closing valve BL and stops the synthesis of the hydrocarbons by the synthesis device 16. Thereafter, the control device 22 brings the system control process to an end.

As noted previously, according to the present embodiment, when the adsorption amount of the carbon dioxide gas adsorbed to the electrodes of the gas adsorption type storage battery 20 exceeds the predetermined threshold value (the first threshold value), the control device 22 controls the discharging switch SW2, and thereby initiates the discharging of the gas adsorption type storage battery 20.

In accordance with this feature, even without providing the reformer, the reformed gas supply line, or the like, electrical power can be stored. As a result, it is possible to reduce restrictions on the installation location. Further, the carbon dioxide gas can be stably acquired by the gas adsorption type storage battery 20, and as a result, the operating rate of the methanation reactor can be increased.

The carbon dioxide gas released from the gas adsorption type storage battery 20 is supplied to the electrolysis device 12. The electrolysis device 12, using the electrical power of the gas adsorption type storage battery 20, is capable of co-electrolyzing the carbon dioxide gas together with the water. Accordingly, it is possible to improve the efficiency of the electrolysis. The generated gas (the hydrogen gas and the carbon monoxide gas) that is obtained by co-electrolysis is stored in the gas tank 14. Accordingly, the gas that is necessary for carrying out synthesis in the synthesis device 16 (the FT synthesis device 16A) is capable of being stored.

In the case that the stored amount of the generated gas exceeds the predetermined threshold value (the second threshold value), the control device 22 controls the opening/closing valve BL, and thereby supplies the generated gas that is stored in the gas tank 14 to the synthesis device 16. On the other hand, in the case that the stored amount of the generated gas is less than or equal to the threshold value (the second threshold value), the control device 22 controls the opening/closing valve BL, and thereby stops supply of the generated gas to the synthesis device 16. Consequently, it is possible to stably supply the gas necessary for carrying out synthesis in the synthesis device 16, and as a result, it is possible to improve the efficiency of the synthesis of hydrocarbons.

According to the present embodiment, the electrolysis device 12 is the co-electrolysis device 12A, and the synthesis device 16 is the FT synthesis device 16A. Consequently, compared to a case in which the hydrocarbons are synthesized using a Sabatier reaction, the energy necessary for carrying out the synthesis can be reduced.

The above-described first embodiment may be modified in the manner described below.

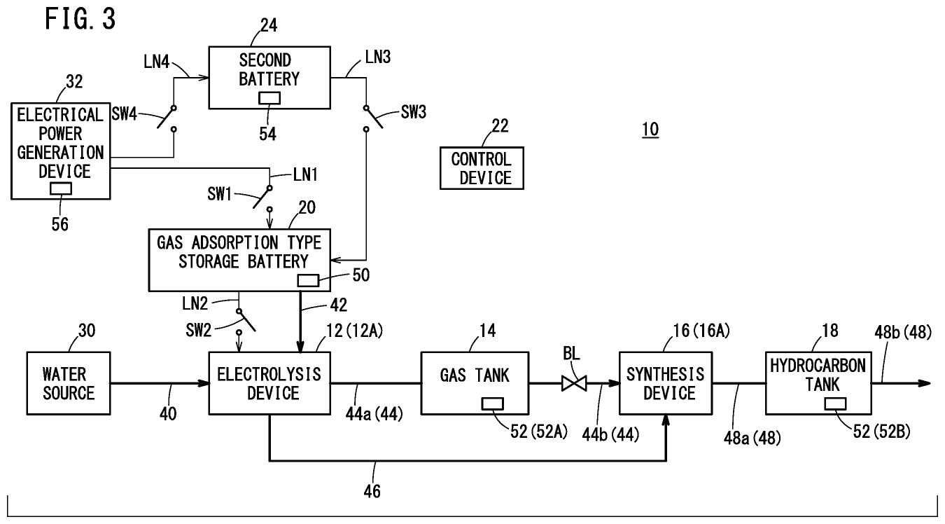

FIG. 3 is a schematic diagram showing the configuration of the electrolytic synthesis system 10 according to an Exemplary Modification of the first embodiment. In FIG. 3, the same reference numerals are assigned to the same constituent elements as those described in the first embodiment. Moreover, according to the present exemplary modification, descriptions which overlap or are duplicative with those of the first embodiment will be omitted.

In the case that the electrical power generation device 32 of the first embodiment is an electrical power generation device that generates renewable energy, then depending on the natural environment, the gas adsorption type storage battery 20 cannot be sufficiently charged. Further, even in the case that the electrical power generation device 32 is not an electrical power generation device that generates renewable energy, then at the time of a power outage or the like, the gas adsorption type storage battery 20 may be incapable of being charged. Thus, as in the electrolytic synthesis system 10 of the present exemplary modification, a second battery 24 may be provided as a reserve power source.

During charging, the second battery 24 does not adsorb the carbon dioxide gas. The second battery 24 is a commonly used secondary battery such as a lithium ion battery or the like. An electrical sensor 54 is provided in the second battery 24. The electrical sensor 54 is a sensor that is used in order to acquire the amount of charge. The electrical sensor 54 may be a current sensor, may be a voltage sensor, or may be a resistance sensor.

The second battery 24 is connected to the gas adsorption type storage battery 20 via a charging line LN3. A second charging switch SW3 is provided in the charging line LN3. The second charging switch SW3 is a switch in order to supply the electrical power of the second battery 24 to the gas adsorption type storage battery 20. In the case that the second charging switch SW3 is turned OFF, the electrical power of the second battery 24 is not supplied to the gas adsorption type storage battery 20. On the other hand, in the case that the second charging switch SW3 is turned ON, the electrical power of the second battery 24 is supplied to the gas adsorption type storage battery 20.

The second battery 24 is connected to the electrical power generation device 32 via a charging line LN4. A third charging switch SW4 is provided in the charging line LN4. The third charging switch SW4 is a switch in order to supply the electrical power of the electrical power generation device 32 to the second battery 24. In the case that the third charging switch SW4 is turned OFF, the electrical power of the electrical power generation device 32 is not supplied to the second battery 24. On the other hand, in the case that the third charging switch SW4 is turned ON, the electrical power of the electrical power generation device 32 is supplied to the second battery 24.

In the case that the second battery 24 is provided, the control device 22 executes a first battery control process, and a second battery control process in parallel with the above-described system control process.

The first battery control process is a process of charging the second battery 24 during the time in which the electrolytic synthesis system 10 is stopped. The control device 22, based on the electrical sensor 54, acquires an amount of charge of the second battery 24, and compares the amount of charge with a predetermined charging threshold value. In the case that the amount of charge of the second battery 24 becomes less than or equal to the predetermined charging threshold value, the control device 22 turns ON the third charging switch SW4 and thereby charges the second battery 24.

The second battery control process is a process of charging the gas adsorption type storage battery 20 or the second battery 24, irrespective of whether or not the electrolytic synthesis system 10 is stopped. The control device 22 compares the electrical power of the electrical power generation device 32 detected by an electrical power sensor 56 provided in the electrical power generation device 32 with a third threshold value.

In the case that the electrical power of the electrical power generation device 32 is greater than or equal to the third threshold value, the control device 22 charges the gas adsorption type storage battery 20 using the electrical power of the electrical power generation device 32. In this case, the first charging switch SW1 is turned ON, and the second charging switch SW3 is turned OFF. On the other hand, in the case that the electrical power of the electrical power generation device 32 is less than the third threshold value, the control device 22 charges the gas adsorption type storage battery 20 using the electrical power of the second battery 24. In this case, the first charging switch SW1 is turned OFF, and the second charging switch SW3 is turned ON.

In this manner, in accordance with the present exemplary modification, the gas adsorption type storage battery 20 can be operated at all times. Therefore, it is possible to prevent the electrolysis device 12 during operation thereof from being stopped unintentionally. As a result, the hydrogen gas and the carbon monoxide gas can be stably supplied to the synthesis device 16 via the gas tank 14.

### Second Embodiment

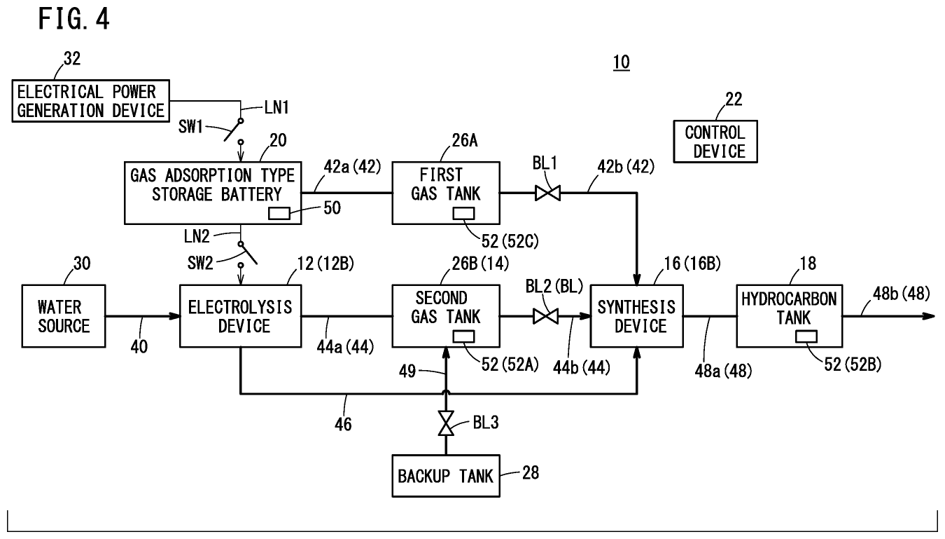

Next, with reference to FIG. 4, a description will be given concerning a second embodiment. In FIG. 4, the same reference numerals are assigned to the same constituent elements as those described in the first embodiment. Moreover, it should be noted that, corresponding to the features of the appended claims, the gas tank 14 of the first embodiment will be referred to as a second gas tank 26B. Similarly, the tank sensor 52A of the first embodiment will be referred to as a second tank sensor 52A. Similarly, the opening/closing valve BL of the first embodiment will be referred to as a second opening/closing valve BL2. Further, in the present embodiment, descriptions which overlap or are duplicative with those of the embodiment will be omitted.

According to the present embodiment, the electrolysis device 12 is a water electrolysis device 12B that subjects water to electrolysis. The water electrolysis device 12B may be an AEM type water electrolysis device, or may be a PEM type water electrolysis device. In an AEM type water electrolysis device, an anion exchange membrane is used as the electrolyte membrane. In a PEM type water electrolysis device, a proton exchange membrane is used as the electrolyte membrane. Moreover, it should be noted that the electrolyte membrane of the water electrolysis device 12B may be the solid electrolyte membrane that is used in the co-electrolysis device 12A.

The generated gas generated by the water electrolysis device 12B is a hydrogen gas. Therefore, according to the present embodiment, the hydrogen gas is stored in the second gas tank 26B. On the other hand, the carbon monoxide gas is not stored in the gas tank 14. Stated otherwise, although the configurations of the gas tank 14 and the second gas tank 26B are the same, the gas components of the generated gas that is stored in the gas tank 14 and the generated gas that is stored in the second gas tank 26B are different from each other.

According to the present embodiment, the synthesis device 16 is a methanation device 16B that causes the hydrogen gas and the carbon dioxide gas to react, and thereby synthesizes the hydrocarbons. The catalyst that is used in the methanation device 16B includes, for example, a metal such as nickel or the like.

According to the present embodiment, the connection of the first pipe 42 differs from that of the first embodiment. In the first embodiment, the first pipe 42 connects the electrolysis device 12 and the gas adsorption type storage battery 20. In contrast thereto, according to the present embodiment, the first pipe 42 connects the electrolysis device 12 and the synthesis device 16.

According to the present embodiment, there are newly provided a first gas tank 26A and a backup tank 28. The first gas tank 26A is provided in the first pipe 42. An inlet port of the first gas tank 26A is connected to a downstream end of an upstream portion 42a of the first pipe 42. An outlet port of the first gas tank 26A is connected to an upstream end of a downstream portion 42b of the first pipe 42. According to the present embodiment, the first pipe 42 places the gas adsorption type storage battery 20 in communication with the synthesis device 16. Therefore, the carbon dioxide gas that is released from the electrodes of each of the storage cells of the gas adsorption type storage battery 20 passes through the first pipe 42, and is stored in the first gas tank 26A. A first opening/closing valve BL1 is provided in the first pipe 42 between the first gas tank 26A and the synthesis device 16.

The backup tank 28 is a tank that stores hydrogen gas for backup purposes. The backup tank 28 is connected to the second gas tank 26B by a third pipe 49. The third pipe 49 places the backup tank 28 in communication with the second gas tank 26B.

A third opening/closing valve BL3 is provided in the third pipe 49 between the backup tank 28 and the second gas tank 26B. In the case that the third opening/closing valve BL3 is closed, the hydrogen gas that is stored in the backup tank 28 is not supplied to the second gas tank 26B. On the other hand, in the case that the third opening/closing valve BL3 is open, the hydrogen gas that is stored in the backup tank 28 is supplied to the second gas tank 26B.

According to the present embodiment, a first tank sensor 52C is newly connected to the control device 22. The first tank sensor 52C is a sensor that is used in order to detect the stored amount of the carbon dioxide gas that is stored in the first gas tank 26A. The first tank sensor 52C, for example, is a pressure sensor, however, the present invention is not limited to this feature.

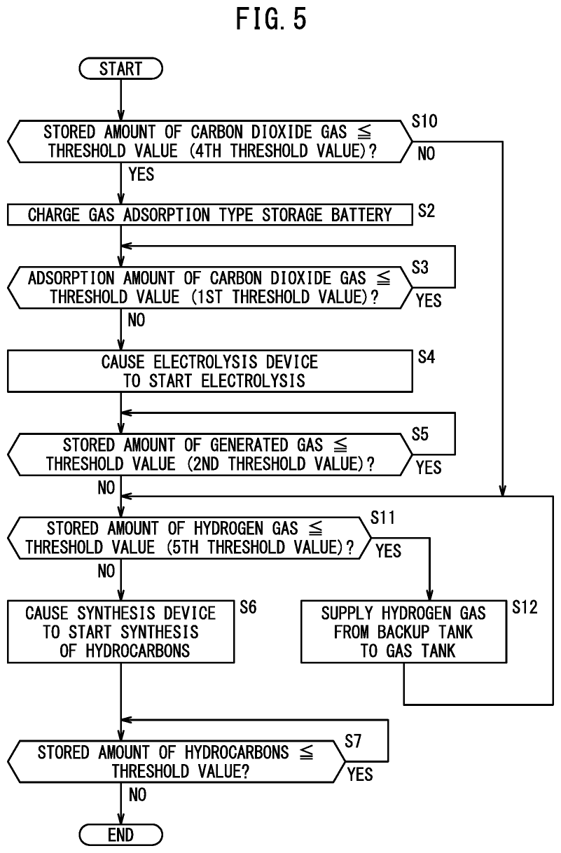

Next, in relation to a system control process of the control device 22, a description thereof will be given in detail using the flowchart shown in FIG. 5. In FIG. 5, the same reference numerals are assigned to the same steps as those described in FIG. 2. Moreover, it should be noted that, in the system control process of the present embodiment, explanations that overlap or are duplicative with those of the system control process of the first embodiment will be omitted.

During a time in which the electrolytic synthesis system 10 is stopped, when a command to start the electrolytic synthesis system 10 is received, the control device 22 initiates the system control process, and then transitions to step S10. Moreover, it should be noted that the first opening/closing valve BL1 and the third opening/closing valve BL3, which are newly provided in the present embodiment, are closed during the time when the electrolytic synthesis system 10 is stopped, in the same manner as the second opening/closing valve BL2, which is the opening/closing valve BL of the first embodiment.

In step S10, the control device 22, based on the first tank sensor 52C, acquires the stored amount of the carbon dioxide gas that is stored in the first gas tank 26A, and compares the stored amount with a predetermined threshold value (a fourth threshold value).

In the case that the stored amount of the carbon dioxide gas is less than or equal to the threshold value (the fourth threshold value), the control device 22 determines that there is a need to replenish the first gas tank 26A with the generated gas. In this case, the control device 22 transitions to step S2. On the other hand, in the case that the stored amount of the carbon dioxide gas exceeds the threshold value (the fourth threshold value), the control device 22 determines that there is no need to replenish the first gas tank 26A with the carbon dioxide gas. In this case, the control device 22 transitions to step S11.

In step S11, the control device 22, based on the second tank sensor 52A, acquires the stored amount of the hydrogen gas that is stored in the second gas tank 26B, and compares the stored amount with a predetermined threshold value (a fifth threshold value).

In the case that the stored amount of the hydrogen gas exceeds the threshold value (the fifth threshold value), the control device 22 determines that there is no need to replenish the second gas tank 26B with the hydrogen gas. In this case, the control device 22 transitions to step S6. On the other hand, in the case that the stored amount of the hydrogen gas is less than or equal to the threshold value (the fifth threshold value), the control device 22 determines that there is a need to replenish the second gas tank 26B with the hydrogen gas. In this case, the control device 22 transitions to step S12.

In step S12, the control device 22 opens the third opening/closing valve BL3, and starts supplying the hydrogen gas that is stored in the backup tank 28 to the second gas tank 26B. In the case that the third opening/closing valve BL3 is opened, the control device 22 continues to supply the hydrogen gas to the second gas tank 26B, until the stored amount of the hydrogen gas exceeds the threshold value (the fifth threshold value). When the stored amount of the hydrogen gas exceeds the threshold value (the fifth threshold value), the control device 22 closes the third opening/closing valve BL3, and thereafter transitions to step S6.

In the foregoing manner, according to the present embodiment, as in the first embodiment, when the adsorption amount of the carbon dioxide gas adsorbed to the electrodes of the gas adsorption type storage battery 20 exceeds the predetermined threshold value (the first threshold value), the control device 22 controls the discharging switch SW2, and thereby initiates the discharging of the gas adsorption type storage battery 20.

In accordance with this feature, even without providing the reformer, the reformed gas supply line, or the like, the electrical power can be stored. As a result, it is possible to reduce restrictions on the installation location. Further, the carbon dioxide gas can be stably acquired by the gas adsorption type storage battery 20, and as a result, the operating rate of the methanation reactor can be increased.

The carbon dioxide gas released from the gas adsorption type storage battery 20 is stored in the first gas tank 26A. The generated gas (the hydrogen gas) obtained by the electrolysis device 12 electrolyzing the water is stored in the second gas tank 26B. Accordingly, the gas that is necessary for carrying out synthesis in the synthesis device 16 (the methanation device 16B) is capable of being stored. Further, using the electrical power of the gas adsorption type storage battery 20, the electrolysis device 12 is capable of electrolyzing water. Accordingly, it is possible to improve the efficiency of the electrolysis.

In the case that the stored amount of the carbon dioxide gas exceeds the fourth threshold value, the control device 22 controls the first opening/closing valve BL1, and thereby supplies the carbon dioxide gas that is stored in the first gas tank 26A to the synthesis device 16. On the other hand, in the case that the stored amount of the carbon dioxide gas is less than or equal to the fourth threshold value, the control device 22 controls the first opening/closing valve BL1, and thereby stops supply of the carbon dioxide gas that is stored in the first gas tank 26A to the synthesis device 16. Consequently, it is possible to stably supply the carbon dioxide gas necessary for carrying out synthesis in the synthesis device 16, and as a result, it is possible to improve the efficiency of the synthesis of hydrocarbons.

In the case that the stored amount of the carbon dioxide gas exceeds the fourth threshold value, and further, the stored amount of the hydrogen gas exceeds the fifth threshold value, the control device 22 controls the first opening/closing valve BL1 and the second opening/closing valve BL2, and thereby supplies the carbon dioxide gas that is stored in the first gas tank 26A and the hydrogen gas that is stored in the second gas tank 26B, to the synthesis device 16. On the other hand, in the case that the stored amount of the carbon dioxide gas exceeds the predetermined fourth threshold value, and further, the stored amount of the hydrogen gas is less than or equal to the fifth threshold value, the control device controls the first opening/closing valve BL1 to the third opening/closing valve BL3, and thereby supplies the carbon dioxide gas that is stored in the first gas tank 26A and the hydrogen gas that is stored in the backup tank 28, to the synthesis device 16. On the other hand, in the case that the stored amount of the carbon dioxide gas is less than or equal to the fourth threshold value, the control device 22 controls the first opening/closing valve BL1 and the second opening/closing valve BL2, and thereby stops supply of the carbon dioxide gas that is stored in the first gas tank 26A and the hydrogen gas that is stored in the second gas tank 26B, to the synthesis device 16. Consequently, it is possible to stably supply both the carbon dioxide gas and the hydrogen gas necessary for carrying out synthesis in the synthesis device 16, and as a result, it is possible to improve the efficiency of the synthesis of hydrocarbons.

The above-described second embodiment may be modified in the manner described below.

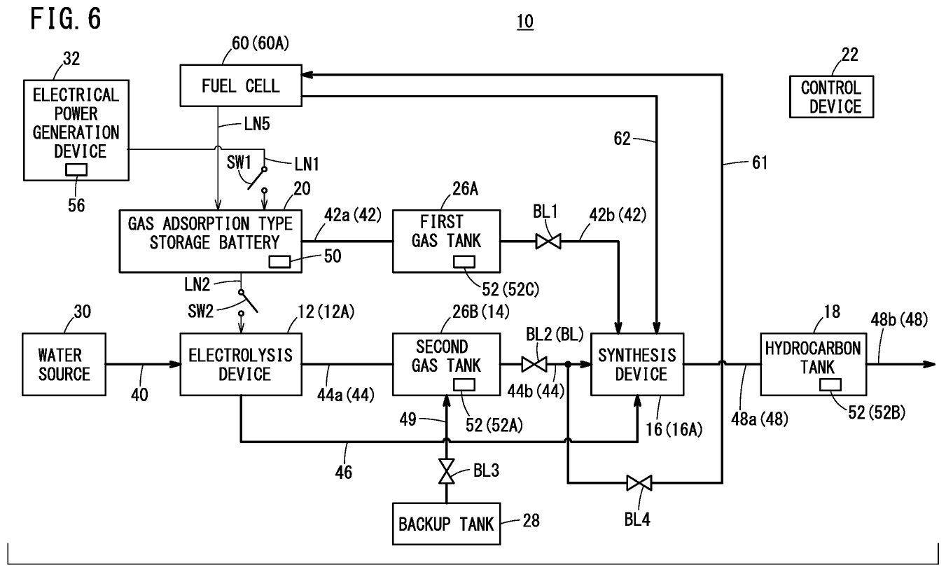

FIG. 6 is a schematic diagram showing the configuration of the electrolytic synthesis system 10 according to an Exemplary Modification 1 of the second embodiment. In FIG. 6, the same reference numerals are assigned to the same constituent elements as those described in the second embodiment. According to the present exemplary modification, descriptions which overlap or are duplicative with those of the second embodiment will be omitted.

In the case that the electrical power generation device 32 of the second embodiment is a device that converts solar energy into electrical power, then during the night, the gas adsorption type storage battery 20 is incapable of being charged. Further, even in the case that the electrical power generation device 32 is not a device that converts solar energy into electrical power, then at the time of a power outage or the like, the gas adsorption type storage battery 20 may be incapable of being charged. Thus, as in the electrolytic synthesis system 10 of the present exemplary modification, a fuel cell 60 may be provided as a reserve power source. The fuel cell 60 is a fuel cell 60A such as a solid polymer electrolyte fuel cell (PEFC), or a solid oxide fuel cell (SOFC) or the like.

The fuel cell 60 is electrically connected to the gas adsorption type storage battery 20 via a discharge line LN5. Hydrogen gas is supplied to the fuel cell 60 via a first branching pipe 61. The first branching pipe 61 branches off from the second pipe 44 between the second gas tank 26B and the synthesis device 16, and is connected to the fuel cell 60. A fourth opening/closing valve BL4 is provided in the first branching pipe 61. When the hydrogen gas is supplied to the fuel cell 60, in the fuel cell 60, generation of electrical power is initiated by way of an electrochemical reaction between the oxygen gas in the atmosphere and the hydrogen gas. When the generation of electrical power is initiated, the gas adsorption type storage battery 20 is charged with the electrical power of the fuel cell 60.

According to the present exemplary modification, in order for the synthesis device 16 to make use of the heat generated in the fuel cell 60, the fuel cell 60 is connected to the synthesis device 16 via a heat conduction pathway 62. The heat conduction pathway 62 is a pathway that serves to conduct the heat generated in the fuel cell 60 to the synthesis device 16. The heat conduction pathway 62 may be the same as the heat conduction pathway 46. Further, the heat conduction pathway 62 may include a heat pipe.

In the case that the fuel cell 60 (the fuel cell 60A) is provided, the control device 22 executes a fuel cell control process in parallel with the above-described system control process. When the fuel cell control process is started, the control device 22 compares the electrical power of the electrical power generation device 32 detected by the electrical power sensor 56 provided in the electrical power generation device 32 with the third threshold value.

In the case that the electrical power of the electrical power generation device 32 is greater than or equal to the third threshold value, the control device 22 charges the gas adsorption type storage battery 20 with the electrical power of the electrical power generation device 32. In this case, the first charging switch SW1 is turned ON, and the fourth opening/closing valve BL4 is closed.

On the other hand, in the case that the electrical power of the electrical power generation device 32 is less than the third threshold value, the control device 22 charges the gas adsorption type storage battery 20 with the electrical power of the fuel cell 60. In this case, the first charging switch SW1 is turned OFF, and the fourth opening/closing valve BL4 is opened.

In this manner, in accordance with the present exemplary modification, the gas adsorption type storage battery 20 can be operated at all times. Therefore, it is possible to prevent the electrolysis device 12 during operation thereof from being stopped unintentionally. As a result, the hydrogen gas and the carbon dioxide gas can be stably supplied to the synthesis device 16 via the gas tank 14.

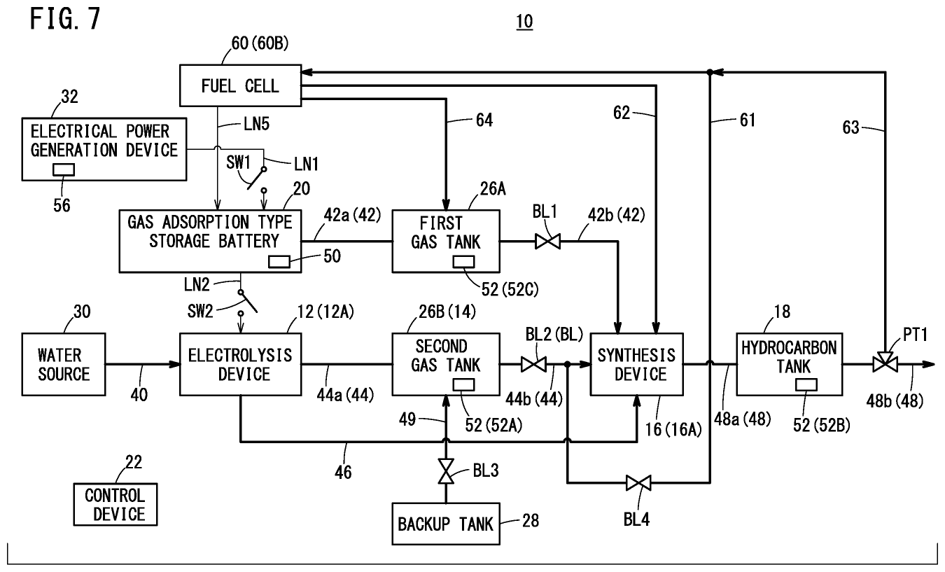

FIG. 7 is a schematic diagram showing the configuration of the electrolytic synthesis system 10 according to an Exemplary Modification 2 of the second embodiment. In FIG. 7, the same reference numerals are assigned to constituent elements that are equivalent to those described previously. According to the present exemplary modification, descriptions which overlap or are duplicative with those of the second embodiment will be omitted.

In the foregoing manner, there may be cases in which the gas adsorption type storage battery 20 cannot be charged. Thus, as in the electrolytic synthesis system 10 of the present exemplary modification, the fuel cell 60 may be provided as a reserve power source. According to the present exemplary modification, the fuel cell 60 is a fuel cell 60B such as a solid oxide fuel cell (SOFC) or the like.

The hydrogen gas is supplied to the fuel cell 60 via the first branching pipe 61. Further, the hydrocarbons are supplied to the fuel cell 60 via a second branching pipe 63. The second branching pipe 63 branches off from the hydrocarbon discharge path 48, and is connected to the fuel cell 60. According to the present exemplary modification, the second branching pipe 63 branches off from the hydrocarbon discharge path 48 on a downstream side of the hydrocarbon tank 18, however, the second branching pipe may also branch off from the hydrocarbon discharge path 48 on an upstream side of the hydrocarbon tank 18. Further, although the second branching pipe 63 is indirectly connected to the fuel cell 60 via the first branching pipe 61, the second branching pipe may also be connected directly to the fuel cell 60 without being connected thereto via the first branching pipe 61. A pathway switching device PT1 is disposed at a branching portion where the second branching pipe 63 branches off from the hydrocarbon discharge path 48. The pathway switching device PT1 is a device that selectively switches between the connection with the second branching pipe 63, and the connection with the hydrocarbon discharge path 48. The pathway switching device PT1 may be a three-way valve.

When the hydrogen gas and the hydrocarbons are supplied to the fuel cell 60, in the fuel cell 60, generation of electrical power is initiated by way of an electrochemical reaction between the oxygen gas in the atmosphere, the hydrogen gas, and the hydrocarbons. When the generation of electrical power is initiated, the gas adsorption type storage battery 20 is charged with the electrical power of the fuel cell 60. Further, the carbon dioxide gas generated by the above-described electrochemical reaction is supplied to the first gas tank 26A via a fourth pipe 64. The fourth pipe 64 is a pipe that connects the fuel cell 60 and the first gas tank 26A, and that places the fuel cell 60 in communication with the first gas tank 26A.

In the case that the fuel cell 60 (the fuel cell 60B) is provided, the control device 22 executes the fuel cell control process in parallel with the above-described system control process. When the fuel cell control process is started, the control device 22 compares the electrical power of the electrical power generation device 32 detected by the electrical power sensor 56 provided in the electrical power generation device 32 with the third threshold value.

In the case that the electrical power of the electrical power generation device 32 is greater than or equal to the third threshold value, the control device 22 charges the gas adsorption type storage battery 20 using the electrical power of the electrical power generation device 32. In this case, the first charging switch SW1 is turned ON, and the fourth opening/closing valve BL4 is closed. Further, the pathway switching device PT1 maintains the connection with the hydrocarbon discharge path 48, without switching to the connection with the second branching pipe 63.

On the other hand, in the case that the electrical power of the electrical power generation device 32 is less than the third threshold value, the control device 22 charges the gas adsorption type storage battery 20 using the electrical power of the fuel cell 60. In this case, the first charging switch SW1 is turned OFF, and the fourth opening/closing valve BL4 is opened. Further, the pathway switching device PT1 switches from the connection with the hydrocarbon discharge path 48 to the connection with the second branching pipe 63.

In this manner, in accordance with the present exemplary modification, the gas adsorption type storage battery 20 can be operated at all times. Therefore, it is possible to prevent the electrolysis device 12 during operation thereof from being stopped unintentionally. As a result, the hydrogen gas and the carbon dioxide gas can be stably supplied to the synthesis device 16 via the gas tank 14.

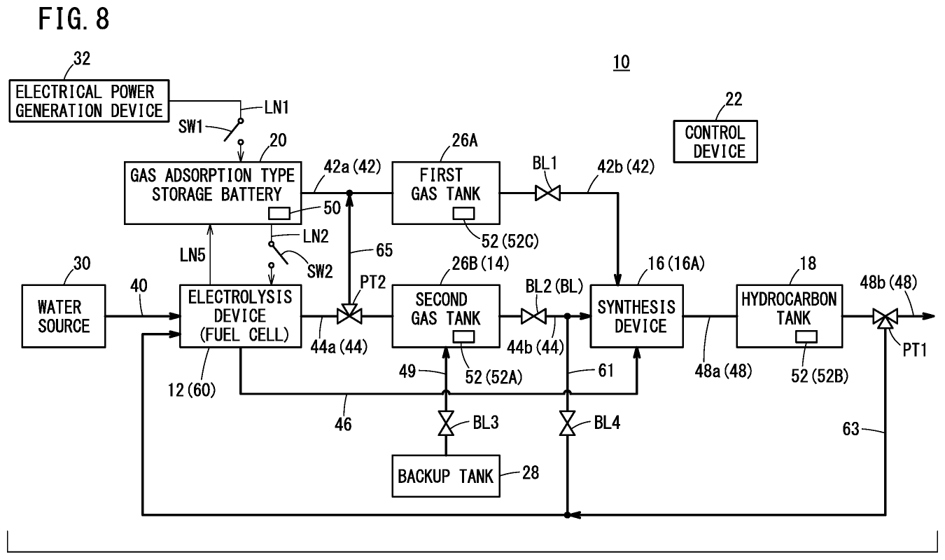

FIG. 8 is a schematic diagram showing the configuration of the electrolytic synthesis system 10 according to an Exemplary Modification 3 of the second embodiment. In FIG. 8, the same reference numerals are assigned to constituent elements that are equivalent to those described previously. According to the present exemplary modification, descriptions which overlap or are duplicative with those of the second embodiment will be omitted.

The fuel cell 60 may be the electrolysis device 12. More specifically, in addition to an electrolysis function, the electrolysis device 12 includes an electrical power generating function. In this case, the control device 22 switches the electrolysis device 12 between an electrolysis mode and a battery mode.

More specifically, in the case that the electrical power of the electrical power generation device 32 is greater than or equal to the third threshold value, the control device 22 causes the electrolysis device 12 to execute the electrolysis mode. In this case, the electrolysis device 12 uses the electrical power of the electrical power generation device 32, and thereby subjects the water to electrolysis.

In the case that the electrolysis device 12 is caused to execute the electrolysis mode, the control device 22 turns ON the first charging switch SW1, and closes the fourth opening/closing valve BL4. Further, the control device 22 controls the pathway switching device PT1, and thereby connects the hydrocarbon discharge path 48 to the pathway switching device PT1. Furthermore, the control device 22 controls a second pathway switching device PT2, and thereby connects the second pipe 44 to the second pathway switching device PT2. Consequently, the hydrogen gas generated by electrolysis being carried out in the electrolysis device 12 is supplied to the second gas tank 26B via the second pipe 44.

The second pathway switching device PT2 is a device that selectively switches between the connection with the second pipe 44, and the connection with a third branching pipe 65. The third branching pipe 65 branches off from the second pipe 44, and is connected to the first pipe 42. The second pathway switching device PT2 is disposed at a branching portion where the third branching pipe 65 branches off from the second pipe 44. The second pathway switching device PT2 may be a three-way valve.

In the case that the electrical power of the electrical power generation device 32 is less than the third threshold value, the control device 22 causes the electrolysis device 12 to execute the battery mode. In this case, the electrolysis device 12 charges the gas adsorption type storage battery 20. More specifically, due to a reverse operation of the electrolysis device 12, the gas adsorption type storage battery 20 is charged by SOFC generation of electrical power by the electrolysis device 12.

In the case that the electrolysis device 12 is caused to execute the battery mode, the control device 22 turns OFF the first charging switch SW1, and opens the fourth opening/closing valve BL4. Further, the control device 22 controls the pathway switching device PT1, and thereby connects the second branching pipe 63 to the pathway switching device PT1. Furthermore, the control device 22 controls the second pathway switching device PT2, and thereby connects the third branching pipe 65 to the second pathway switching device PT2. Consequently, the electrolysis device 12 carries out the generation of electrical power, whereby the gas adsorption type storage battery 20 is charged. Further, the carbon dioxide gas generated due to the generation of electrical power by the electrolysis device 12 passes through the third branching pipe 65 and the first pipe 42 in this order and is then supplied to the first gas tank 26A.

In this manner, in accordance with the present exemplary modification, the gas adsorption type storage battery 20 can be operated at all times. Therefore, it is possible to prevent the electrolysis device 12 during operation thereof from being stopped unintentionally. As a result, the hydrogen gas and the carbon dioxide gas can be stably supplied to the synthesis device 16 via the gas tank 14. Further, according to the present embodiment, since there is no need to provide the fuel cell 60 separately from the electrolysis device 12, the number of the component parts can be reduced.

In relation to the disclosure provided above, hereinafter, the following Supplementary Notes are mentioned.

### Supplementary Note 1

The present disclosure is characterized by the electrolytic synthesis system (10) equipped with the electrolysis device (12) that carries out electrolysis on water vapor and thereby generates hydrogen gas, and the synthesis device (16) that uses the hydrogen gas and thereby synthesizes the hydrocarbons, the electrolytic synthesis system including the gas adsorption type storage battery (20) that adsorbs, to the electrodes, the carbon dioxide gas within the atmosphere, together with the electrons, during charging, and releases, from the electrodes, together with the electrons, the carbon dioxide gas that was adsorbed to the electrodes, during discharging, the first pipe (42) that connects the gas adsorption type storage battery and the electrolysis device or the synthesis device, wherein the carbon dioxide from the gas adsorption type storage battery flows through the first pipe, the discharging switch (SW2) for supplying the electrical power of the gas adsorption type storage battery to the electrolysis device, the adsorption sensor (50) that acquires the adsorption amount of the carbon dioxide gas adsorbed to the electrodes, and the control device (22) including the one or more processors, wherein, in the case that the adsorption amount exceeds the predetermined first threshold value, the control device controls the discharging switch and thereby initiates discharging of the gas adsorption type storage battery.

In accordance with this feature, even without providing the reformer, the reformed gas supply line, or the like, electrical power can be stored. As a result, it is possible to reduce restrictions on the installation location. Further, the carbon dioxide gas can be stably acquired owing to the gas adsorption type storage battery, and as a result, the operating rate of the methanation reactor can be increased.

### Supplementary Note 2

The electrolytic synthesis system according to Supplementary Note 1 may further include the second pipe (44) through which the generated gas containing the hydrogen gas generated by the electrolysis device flows to the synthesis device, the gas tank (14) disposed in the second pipe, and that stores the generated gas generated by the electrolysis device, the opening/closing valve (BL) provided in the second pipe between the gas tank and the synthesis device, and the tank sensor (52A) in order to acquire the stored amount of the generated gas that is stored in the gas tank, wherein the first pipe may connect the gas adsorption type storage battery and the electrolysis device, and in the case that the stored amount exceeds the predetermined second threshold value, the control device may control the opening/closing valve, and thereby supply the generated gas that is stored in the gas tank to the synthesis device, and in the case that the stored amount is less than or equal to the second threshold value, the control device may control the opening/closing valve, and thereby stop supply of the generated gas that is stored in the gas tank to the synthesis device.

In accordance with such features, it is possible to stably supply the gas necessary for carrying out synthesis in the synthesis device, and as a result, it is possible to improve the efficiency of the synthesis of hydrocarbons.

### Supplementary Note 3

In the electrolytic synthesis system according to Supplementary Note 2, the electrolysis device may be the co-electrolysis device (12A) that subjects the carbon dioxide gas and the water vapor to co-electrolysis, and the synthesis device may be the FT (Fischer-Tropsch) synthesis device (16A) that causes the hydrogen gas and the carbon monoxide generated by co-electrolysis to react with each other and thereby synthesizes the hydrocarbons.

In accordance with this feature, compared to a case in which the hydrocarbons are synthesized using the Sabatier reaction, the energy necessary for carrying out the synthesis can be reduced.

### Supplementary Note 4

The electrolytic synthesis system according to Supplementary Note 1 may further include the second battery (24) other than the gas adsorption type storage battery, the first charging switch (SW1) that supplies the electrical power of the electrical power generation device (32) to the gas adsorption type storage battery, and the second charging switch (SW3) that supplies the electrical power of the second battery to the gas adsorption type storage battery, wherein, in the case that the electrical power of the electrical power generation device is greater than or equal to the third threshold value, the control device may control the first charging switch and the second charging switch, and thereby charge the gas adsorption type storage battery using the electrical power of the electrical power generation device, and in the case that the electrical power of the electrical power generation device is less than the third threshold value, the control device may control the first charging switch and the second charging switch, and thereby charge the gas adsorption type storage battery using the electrical power of the second battery.

In accordance with such features, the gas adsorption type storage battery can be constantly operated. Therefore, it is possible to prevent the electrolysis device during operation thereof from being stopped unintentionally. As a result, it is possible to stably supply the generated gas to the synthesis device via the gas tank.

### Supplementary Note 5

The electrolytic synthesis system according to Supplementary Note 1 may further include the first gas tank (26A) provided in the first pipe connecting the gas adsorption type storage battery and the synthesis device, and that stores the carbon dioxide gas released from the gas adsorption type storage battery, the first opening/closing valve (BL1) provided in the first pipe between the first gas tank and the synthesis device, and the first tank sensor (52C) that acquires the stored amount of the carbon dioxide gas that is stored in the first gas tank, wherein, in the case that the stored amount of the carbon dioxide gas exceeds the predetermined fourth threshold value, the control device may control the first opening/closing valve, and thereby supply the carbon dioxide gas that is stored in the first gas tank to the synthesis device, and in the case that the stored amount of the carbon dioxide gas is less than or equal to the fourth threshold value, the control device may control the first opening/closing valve, and thereby stop supply of the carbon dioxide gas that is stored in the first gas tank to the synthesis device.

In accordance with such features, it is possible to stably supply the carbon dioxide gas necessary for carrying out synthesis in the synthesis device, and as a result, it is possible to improve the efficiency of the synthesis of hydrocarbons.

### Supplementary Note 6

The electrolytic synthesis system according to Supplementary Note 5 may further include the second pipe (44) through which the hydrogen gas generated by the electrolysis device flows to the synthesis device, the second gas tank (26B) provided in the second pipe, and that stores the hydrogen gas generated by the electrolysis device, the second opening/closing valve (BL2) provided in the second pipe between the second gas tank and the synthesis device, the second tank sensor (52A) that acquires the stored amount of the hydrogen gas that is stored in the second gas tank, the backup tank (28) that stores the hydrogen gas, the third pipe (49) that connects the backup tank and the second gas tank, and the third opening/closing valve (BL3) provided in the third pipe between the backup tank and the second gas tank, wherein, in the case that the stored amount of the carbon dioxide gas exceeds the predetermined fourth threshold value, and further, the stored amount of the hydrogen gas exceeds the fifth threshold value, the control device may control the first opening/closing valve and the second opening/closing valve, and thereby supply the carbon dioxide gas that is stored in the first gas tank and the hydrogen gas that is stored in the second gas tank to the synthesis device, in the case that the stored amount of the carbon dioxide gas exceeds the fourth threshold value, and further, the stored amount of the hydrogen gas is less than or equal to the fifth threshold value, the control device may control the first opening/closing valve to the third opening/closing valve, and thereby supply the carbon dioxide gas that is stored in the first gas tank and the hydrogen gas that is stored in the backup tank to the synthesis device, and in the case that the stored amount of the carbon dioxide gas is less than or equal to the fourth threshold value, the control device may control the first opening/closing valve and the second opening/closing valve, and thereby stop supply of the carbon dioxide gas that is stored in the first gas tank and the hydrogen gas that is stored in the second gas tank to the synthesis device.

In accordance with such features, it is possible to stably supply the hydrogen gas and the carbon dioxide gas necessary for carrying out synthesis in the synthesis device, and as a result, it is possible to improve the efficiency of the synthesis of hydrocarbons.

### Supplementary Note 7

The electrolytic synthesis system according to Supplementary Note 6 may further include the fuel cell (60), the first branching pipe (61) that branches off from the second pipe between the second opening/closing valve and the synthesis device, and is connected to the fuel cell, and the fourth opening/closing valve (BL4) provided in the first branching pipe, wherein, in the case that the electrical power of the electrical power generation device that is supplied to the gas adsorption type storage battery is greater than or equal to the third threshold value, the control device may control the first charging switch that supplies the electrical power of the electrical power generation device to the gas adsorption type storage battery, and thereby charge the gas adsorption type storage battery using the electrical power of the electrical power generation device, and in the case that the electrical power of the electrical power generation device is less than the third threshold value, the control device may control the fourth opening/closing valve and thereby supply the hydrogen gas to the fuel cell, and thereby charge the gas adsorption type storage battery using the electrical power of the fuel cell.

In accordance with such features, the gas adsorption type storage battery can be constantly operated. Therefore, it is possible to prevent the electrolysis device during operation thereof from being stopped unintentionally. As a result, the hydrogen gas and the carbon dioxide gas can be stably supplied to the synthesis device.

### Supplementary Note 8

The electrolytic synthesis system according to Supplementary Note 7 may further include the second branching pipe (63) that branches off from the hydrocarbon discharge path (48) and is connected to the fuel cell, wherein the hydrocarbons synthesized by the synthesis device flow through the hydrocarbon discharge path, the pathway switching device (PT1) disposed at the branching portion where the second branching pipe branches off from the hydrocarbon discharge path, and that selectively switches between the connection with the second branching pipe and the connection with the hydrocarbon discharge path, and the fourth pipe (64) that connects the fuel cell and the first gas tank, wherein, in the case that the electrical power of the electrical power generation device is less than the third threshold value, the control device may control the fourth opening/closing valve and the pathway switching device, and thereby supply the hydrogen gas and the hydrocarbons to the fuel cell, and cause the fuel cell to generate electrical power.

In accordance with such features, the gas adsorption type storage battery can be constantly operated. Therefore, it is possible to prevent the electrolysis device during operation thereof from being stopped unintentionally. As a result, the hydrogen gas and the carbon dioxide gas can be stably supplied to the synthesis device.

### Supplementary Note 9

The electrolytic synthesis system according to Supplementary Note 8 may further include the third branching pipe (65) that branches off from the second pipe, and is connected to the first pipe, and the second pathway switching device (PT2) disposed at the branching portion where the third branching pipe branches off from the second pipe, and that selectively switches between the connection with the second pipe and the connection with the third branching pipe, wherein the fuel cell is the electrolysis device, and in the case that the electrical power of the electrical power generation device is less than the third threshold value, the control device may control the second pathway switching device and thereby supply, to the first gas tank, the carbon dioxide gas generated by the generation of electrical power in the electrolysis device.

In accordance with such features, the gas adsorption type storage battery can be constantly operated. Therefore, it is possible to prevent the electrolysis device during operation thereof from being stopped unintentionally. As a result, the hydrogen gas and the carbon dioxide gas can be stably supplied to the synthesis device. Furthermore, since there is no need to provide the fuel cell separately from the electrolysis device, the number of the component parts can be reduced.

Moreover, the present invention is not limited to the above-described disclosure, and various configurations can be adopted therein without departing from the essence and gist of the present invention.

1. An electrolytic synthesis system comprising:
an electrolysis device configured to carry out electrolysis on water vapor and thereby generate a hydrogen gas;
a synthesis device configured to use the hydrogen gas and thereby synthesize a hydrocarbon;
a gas adsorption type storage battery configured to adsorb, to an electrode, a carbon dioxide gas within an atmosphere, together with electrons, during charging, and to release, from the electrode, together with the electrons, the carbon dioxide gas that was adsorbed to the electrode, during discharging;
a first pipe that connects the gas adsorption type storage battery and the electrolysis device or the synthesis device, wherein carbon dioxide from the gas adsorption type storage battery flows through the first pipe;
a discharging switch configured to supply electrical power of the gas adsorption type storage battery to the electrolysis device;
an adsorption sensor configured to acquire an adsorption amount of the carbon dioxide gas adsorbed to the electrode; and
a control device including one or more processors,
wherein, in a case that the adsorption amount exceeds a predetermined first threshold value, the control device controls the discharging switch and thereby initiates discharging of the gas adsorption type storage battery.

2. The electrolytic synthesis system according to claim 1, further comprising:
a second pipe through which a generated gas containing the hydrogen gas generated by the electrolysis device flows to the synthesis device;
a gas tank disposed in the second pipe, and configured to store the generated gas generated by the electrolysis device;
an opening/closing valve provided in the second pipe between the gas tank and the synthesis device; and
a tank sensor configured to acquire a stored amount of the generated gas that is stored in the gas tank,
wherein the first pipe connects the gas adsorption type storage battery and the electrolysis device; and
in a case that the stored amount exceeds a predetermined second threshold value, the control device controls the opening/closing valve, and thereby supplies the generated gas that is stored in the gas tank to the synthesis device, and in a case that the stored amount is less than or equal to the second threshold value, the control device controls the opening/closing valve, and thereby stops supply of the generated gas that is stored in the gas tank to the synthesis device.

3. The electrolytic synthesis system according to claim 2, wherein:
the electrolysis device is a co-electrolysis device configured to co-electrolyze the carbon dioxide gas and the water vapor; and
the synthesis device is a Fischer-Tropsch synthesis device configured to cause the hydrogen gas and carbon monoxide generated by co-electrolysis to react with each other and thereby synthesize the hydrocarbon.

4. The electrolytic synthesis system according to claim 1, further comprising:
a second battery other than the gas adsorption type storage battery;
a first charging switch configured to supply electrical power of an electrical power generation device to the gas adsorption type storage battery; and
a second charging switch configured to supply electrical power of the second battery to the gas adsorption type storage battery,
wherein, in a case that the electrical power of the electrical power generation device is greater than or equal to a third threshold value, the control device controls the first charging switch and the second charging switch, and thereby charges the gas adsorption type storage battery using the electrical power of the electrical power generation device, and in a case that the electrical power of the electrical power generation device is less than the third threshold value, the control device controls the first charging switch and the second charging switch, and thereby charges the gas adsorption type storage battery using the electrical power of the second battery.

5. The electrolytic synthesis system according to claim 1, further comprising:
a first gas tank provided in the first pipe connecting the gas adsorption type storage battery and the synthesis device, and configured to store the carbon dioxide gas released from the gas adsorption type storage battery;
a first opening/closing valve provided in the first pipe between the first gas tank and the synthesis device; and
a first tank sensor configured to acquire a stored amount of the carbon dioxide gas that is stored in the first gas tank,
wherein, in a case that the stored amount of the carbon dioxide gas exceeds a predetermined fourth threshold value, the control device controls the first opening/closing valve, and thereby supplies the carbon dioxide gas that is stored in the first gas tank to the synthesis device, and in a case that the stored amount of the carbon dioxide gas is less than or equal to the fourth threshold value, the control device controls the first opening/closing valve, and thereby stops supply of the carbon dioxide gas that is stored in the first gas tank to the synthesis device.

6. The electrolytic synthesis system according to claim 5, further comprising:
a second pipe through which the hydrogen gas generated by the electrolysis device flows to the synthesis device;
a second gas tank provided in the second pipe, and configured to store the hydrogen gas generated by the electrolysis device;
a second opening/closing valve provided in the second pipe between the second gas tank and the synthesis device;
a second tank sensor configured to acquire a stored amount of the hydrogen gas that is stored in the second gas tank;
a backup tank configured to store the hydrogen gas;
a third pipe that connects the backup tank and the second gas tank; and
a third opening/closing valve provided in the third pipe between the backup tank and the second gas tank,
wherein, in a case that the stored amount of the carbon dioxide gas exceeds the predetermined fourth threshold value, and further, the stored amount of the hydrogen gas exceeds a fifth threshold value, the control device controls the first opening/closing valve and the second opening/closing valve, and thereby supplies the carbon dioxide gas that is stored in the first gas tank and the hydrogen gas that is stored in the second gas tank to the synthesis device;
in a case that the stored amount of the carbon dioxide gas exceeds the fourth threshold value, and further, the stored amount of the hydrogen gas is less than or equal to the fifth threshold value, the control device controls the first opening/closing valve, the second opening/closing valve, and the third opening/closing valve, and thereby supplies the carbon dioxide gas that is stored in the first gas tank and the hydrogen gas that is stored in the backup tank to the synthesis device; and
in the case that the stored amount of the carbon dioxide gas is less than or equal to the fourth threshold value, the control device controls the first opening/closing valve and the second opening/closing valve, and thereby stops supply of the carbon dioxide gas that is stored in the first gas tank and the hydrogen gas that is stored in the second gas tank to the synthesis device.

7. The electrolytic synthesis system according to claim 6, further comprising:
a fuel cell;
a first branching pipe that branches off from the second pipe between the second opening/closing valve and the synthesis device, and is connected to the fuel cell; and
a fourth opening/closing valve provided in the first branching pipe,
wherein, in a case that electrical power of an electrical power generation device that is supplied to the gas adsorption type storage battery is greater than or equal to a third threshold value, the control device controls a first charging switch configured to supply the electrical power of the electrical power generation device to the gas adsorption type storage battery, and thereby charges the gas adsorption type storage battery using the electrical power of the electrical power generation device, and in a case that the electrical power of the electrical power generation device is less than the third threshold value, the control device controls the fourth opening/closing valve and thereby supplies the hydrogen gas to the fuel cell, and thereby charges the gas adsorption type storage battery using electrical power of the fuel cell.

8. The electrolytic synthesis system according to claim 7, further comprising:
a second branching pipe that branches off from a hydrocarbon discharge path and is connected to the fuel cell, wherein the hydrocarbon synthesized by the synthesis device flows through the hydrocarbon discharge path;
a pathway switching device disposed at a branching portion where the second branching pipe branches off from the hydrocarbon discharge path, and configured to selectively switch between a connection with the second branching pipe and a connection with the hydrocarbon discharge path; and
a fourth pipe that connects the fuel cell and the first gas tank,
wherein, in the case that the electrical power of the electrical power generation device is less than the third threshold value, the control device controls the fourth opening/closing valve and the pathway switching device, and thereby supplies the hydrogen gas and the hydrocarbon to the fuel cell, and causes the fuel cell to generate electrical power.

9. The electrolytic synthesis system according to claim 8, further comprising:
a third branching pipe that branches off from the second pipe, and is connected to the first pipe; and
a second pathway switching device disposed at a branching portion where the third branching pipe branches off from the second pipe, and configured to selectively switch between a connection with the second pipe and a connection with the third branching pipe,
wherein the fuel cell is the electrolysis device; and
in the case that the electrical power of the electrical power generation device is less than the third threshold value, the control device controls the second pathway switching device, and thereby supplies, to the first gas tank, the carbon dioxide gas generated by generation of electrical power in the electrolysis device.
